(19) United States
(12) Patent Application Publication
(10) Pub. No.: US 2008/0177819 A1
(43) Pub. Date: Jul. 24, 2008

(54) SYSTEM AND METHOD FOR CONTEXTUAL CALL-FOR-ACTIONS

(76) Inventors: Eran Reshef, Tel Aviv (IL); Amir Hirsh, Tel Aviv (IL)

Correspondence Address: DREIER LLP, 499 PARK AVE, NEW YORK, NY, 10022, US

(21) Appl. No.: 12/017,620

(22) Filed: Jan. 22, 2008

Related U.S. Application Data
(60) Provisional application No. 60/886,035, filed on Jan. 22, 2007.

(51) Int. Cl. G06F 15/16

(52) U.S. Cl. 709/201

(57) ABSTRACT

A method and system for contextual calls-for-actions (CCFAs) includes providing a plurality of CCFAs from a coordination center to a plurality of supporters, including providing the CCFAs to computing devices of the supporters. The method and system further includes determining if a supporter is conducting an action context (AC). Whereby in the method and system, if the supporter is conducting the AC, selecting a call-for-action (CFA) corresponding to the AC and thereby electronically providing the CFA to the supporter. Accordingly, the supporter timely receives notations, instructions, reminder, etc. for performing the CFA relative to the user's AC.

### PRIORITY CLAIM

This application is claims the benefit of U.S. Provisional Application No. 60/886,035, entitled “SYSTEM AND METHOD FOR CONTEXTUAL CALL-FOR-ACTIONS,” filed on Jan. 22, 2007, which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention is directed to computer networks, and more particularly to a system and method for performing contextual call-for-actions using computer networks.

### BACKGROUND OF THE INVENTION

Many social actions can be performed on the Internet, such as contacting a Senator, leaving a comment on a political blog or writing the local media. Most social actions are initiated by an organization to which the supporters belong to. Usually email sent by the organizations is used to ask the supporters to perform the social actions. However, such call-for-actions do not take into account the user's context while receiving the call-for-action.

In other words, the call-for-actions are made out of context. This is a situation similar to showing an advertisement to a user without taking into account his or her context.

It is a well known marketing fact that contextual advertising works better than context-less advertisement. Having ads appearing on websites or other media, such as content displayed in mobile phones, where the advertisements are selected and served based on the content displayed or requested by the user, makes the ads more likely to get clicked, thus generating revenue for the owner of the website (and the server of the advertisement).

Many systems exist today to send and receive contextual ads. Some operate on the server-side (e.g., Google's AdSense) and some on the client-side (e.g., adwares). However, there is no system or method for delivering contextual call-for-actions, increasing the likelihood of supporters participating in the action requested in the call-for-actions, as well as increasing the amount of call-for-actions an organization may issue without causing a backlash among its supporters.

### BRIEF SUMMARY OF THE INVENTION

A method and system for contextual calls-for-actions (CCFAs) includes providing a plurality of CCFAs from a coordination center to a plurality of supporters, including providing the CCFAs to computing devices of the supporters. The method and system further includes determining if a supporter is conducting an action context (AC). Whereby in the method and system, if the supporter is conducting the AC, the system and method includes selecting a call-for-action (CFA) corresponding to the AC and thereby electronically providing the CFA to the supporter. Accordingly, the supporter timely receives notations, instructions, reminders, etc. for performing the CFA relative to the user's AC.

The invention allows the creation of CFAs, such as texts, images, web links, audio, video or other formats allowing the display of a call-for-action, together with ACs, such as reading a local news paper, browsing a social network sites, watching movies online, sending emails, sharing files, or any other kind of activity.

The invention distributes CCFAs from the coordination center to a community of supporters. Techniques include, but are not limited to having the supporters' computing devices constantly poll for new CFAs together with the supporter's ACs, or by having the supporter's devices continuously submit their current context to the coordination center and ask for a relevant CFA.

The invention displays relevant CFA's whenever there is a match between an AC and the current context of the individual supporter's computing device by continuously keeping track of the current context.

The invention allows the monitoring and managing the response rate to specific CCFAs by collecting statistics from individual supporters' computing devices about the CFAs displayed to supporters and the actions taken by said supporters, and reporting these statistics to the coordination center.

One type of a method for communicating CCFAs includes displaying a textual call-for-action while the supporter browses a website of specific newspaper, requesting the supporter to fax a letter to the editor of said newspaper asking for coverage of a certain issue.

Another example of mechanism for communicating CCFAs includes displaying a call-for-action while the supporter uses a social network site, requesting the supporter to resend the call-for-action to all his or her online friends on said social network site, thus increasing the amount of people who receive said call-for-action.

Another communicating CCFAs mechanism can include displaying a short movie while the supporter uses an online banking service, requesting the supporter to donate money for a certain cause using said online banking service.

Another example of a mechanism for communicating CCFAs includes displaying a graphical banner while the supporter composes an email within an email program or online service, requesting the supporter to the add banner to the bottom of his or her outgoing email as a way to educate the recipient about a certain cause.

Another example of a mechanism for communicating CCFAs includes playing a political song while the supporter uses a peer-to-peer network, requesting the supporter to share said song on said peer-to-peer network, thus increasing the reach of said song to potential listeners.

Another example of a mechanism for communicating CCFAs includes displaying a call-for-action while the supporter is viewing a web page that includes phrases relevant to the call-for-action.

The invention can be used to increase the likelihood of supporters actually acting upon each call-for-action, compared to existing, non-contextual means of communicating calls-for-action.

The invention can be used to increase the number of calls-for-actions issued at the same time without alienating supporters, compared to existing, non-contextual means of communicating calls-for-action because the CFAs are timely and contextual to what the support is doing instead of being a nuisance when the reminder is unrelated to a supporter's current actions.

The invention can be used to create permanent calls-for-action, compared to existing, non-contextual means of communicating calls-for-action, which are transitory in nature.

Other aspects would become apparent to those skilled in the relevant art(s) in view of the teachings of the present disclosure. Additional aspects of the present invention would be apparent in view of the description that follows.

### BRIEF DESCRIPTION OF THE DRAWINGS

The foregoing and other aspects of the invention will become more apparent from the following description of illustrative embodiments thereof and the accompanying drawings, which illustrate, by way of example, the principles of the invention. In the drawings:

FIG. 1 illustrates a contextual calls-for-action system;

FIG. 2 illustrates the components of a CCFA engine and its internal data flow;

FIG. 3 illustrates a sample screenshot of a CCFA while a supporter reads news online;

FIG. 4 illustrates a sample screenshot of a CCFA while a supporter composes an email;

FIG. 5 illustrates a sample screenshot of a CCFA while a supporter is communicating with friends on a social network; and

FIG. 6 illustrates a flowchart of the steps of one embodiment of a method of requesting CCFAs.

### DETAILED DESCRIPTION OF ILLUSTRATIVE EMBODIMENTS

The present invention will now be described in detail with reference to the drawings, which are provided as illustrative examples of the invention so as to enable those skilled in the relevant art(s) to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be limited to other embodiments including a plurality of the same component, and vice-versa, unless explicitly stated otherwise herein. Further, the present invention encompasses present and future known equivalents to the known components referred to herein by way of illustration.

### Overview of a Contextual Calls-for-Action System

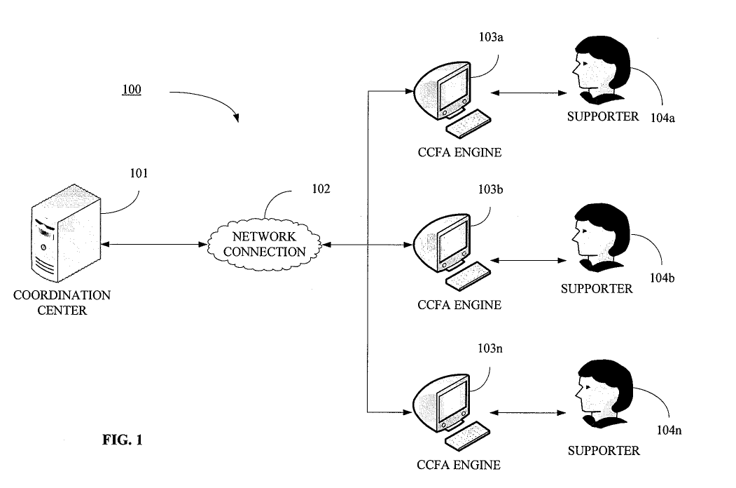

FIG. 1 illustrates a contextual calls-for-action (CCFA) system 100 that includes a coordination center 101, a communications network 102 and a plurality of CCFA Engines 103a-103n executable on computing device belonging to supporters 104a-104n, where n may be any suitable integer. The CCFA Engines are generally referred to by reference numeral 103 and the supporters are generally referred to by reference number 104. A contextual calls-for-action system 100 is configured to communicate correct CCFAs to each of the supporters 104 through the CFA engine 103 via the network 102.

The CCFA Engines 103a-103n may use a wired and/or wireless personal computer, personal digital assistant (PDA), enhanced telephone, personal television, or other data processing device linked to communications network 102 to communicate with coordination center 101. Where direct or active connection may not be available, the CCFA engine 103 and the coordination center 101 may conduct iterative communication, for example the CCFA engine 103 connecting with the communication center 101 at a defined time interval or only when the communication is active.

As explained in greater detail below, the coordination center 101 provides CCFAs to each of the CCFA Engines 103a-103n, which in turn choose and display a specific CCFA to the supporters 104a-104n when the context of a supporter's computing device matches the AC of said CCFA. In one embodiment, the CCFAs may be encoded using programming that includes a CFA as well as corresponding AC details so that actions of the supporters 104 can be compared to the ACs. The CCFAs provide instructions or suggestions for particular CFAs based on the ACs so that the CCFA data may also include AC data, which can include descriptions of various actions that can trigger the display of the CFA itself.

For example, supporters 104a-104n may be alerted to fax a letter to the editor of said newspaper while browsing its website, forward a call-for-action to all his or her online friends while participating in a social network, donate money while using an online banking service or share a political song while using a P2P network.

A coordination center 101 can be implemented via one or more servers, with each server being one or more computers providing various shared resources with each other and to other system components. The shared resources include files for programs, web pages, databases and libraries; output devices, such as, printers, plotters, display monitors and facsimile machines; communications devices, such as modems and Internet access facilities; and other peripherals such as scanners, or the like. The communication devices can support wired or wireless communications, including satellite, terrestrial (fiber optic, copper, coaxial, and the like), radio, microwave, free-space optics, and/or any other form or method of transmission.

The server hosting a coordination center 101 can be configured to support the standard Internet Protocol (IP) developed to govern communications over public and private Internet backbones. The protocol is defined in Internet Standard (STD) 5, Request for Comments (RFC) 791 (Internet Architecture Board). The server also supports transport protocols, such as, Transmission Control Protocol (TCP), User Datagram Protocol (UDP), Real Time Transport Protocol (RTP), or Resource Reservation Protocol (RSVP). The transport protocols support various types of data transmission standards, such as File Transfer Protocol (FTP), Hypertext Transfer Protocol (HTTP), Simple Network Management Protocol (SNMP), Network Time Protocol (NTP), or the like.

Communications network 102 provides a transmission medium for communicating among the system components. Communications network 102 includes a wired and/or wireless local area network (LAN), wide area network (WAN), or metropolitan area network (MAN), such as an organization's intranet, a local internet, the global-based Internet (including the World Wide Web (WWW)), an extranet, a virtual private network, licensed wireless telecommunications spectrum for digital cell (including CDMA, TDMA, GSM, EDGE, GPRS, CDMA2000, WCDMA FDD and/or TDD or TD-SCDMA technologies), or the like. Communications network 102 includes wired, wireless, or both transmission media, including satellite, terrestrial (e.g., fiber optic, copper, UTP, STP, coaxial, hybrid fiber-coaxial (HFC), or the like), radio, free-space optics, microwave, and/or any other form or method of transmission.

### CCFA Engine Overview

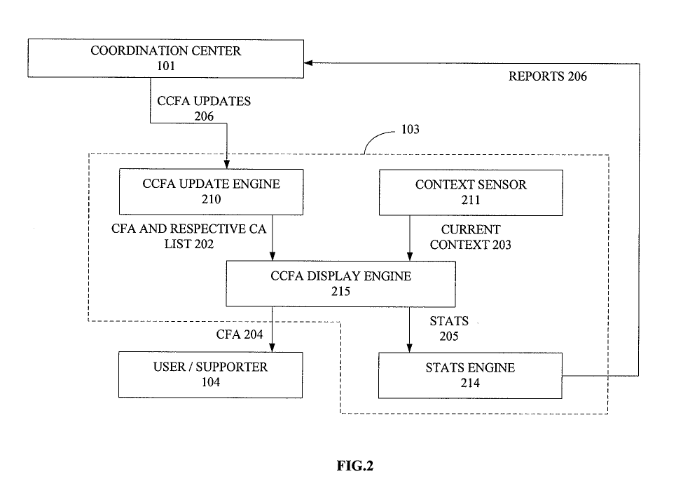

FIG. 2 illustrates an embodiment of CCFA Engine 103. However, the present invention is not implicitly or explicitly limited to such an embodiment, and various alternative models and organizations would become apparent to those skilled in the relevant art(s) after being taught by the present example. The components of FIG. 2 can be implemented using a combination of computer hardware, firmware, and software, using engineering design techniques and network protocols that are guided by the principles of the present invention as would become apparent from the detailed descriptions herein. For example, in one embodiment, all components can be implemented as software components running on top of standard personal computers running the Windows® operating systems available from Microsoft Corporation (Redmond, Wash.) or any other suitable processing environment.

The components of CCFA Engine 103 include a CCFA Update Engine 210, a Context Sensor 211, a CCFA Display Engine 215, and a Stats Engine 214. As illustrated, the CCFA engine 103 is in operative communication with the coordination center 101, which may be via the network 102 of FIG. 1, not explicitly illustrated herein. For brevity, the components in the CCFA engine are described relative to their processing operations. Moreover, it is recognized that additional processing elements, components or modules for processing operations in the CCFA engine, as recognized by one having ordinary skill in the art, are omitted for brevity purposes only.

The CCFA Update Engine 210 receives CCFA Updates 206 from Coordination Center 101. The CCFA updates 206 may be new CCFAs or changes to existing CCFAs, such as updating the CFA or AC data. The CCFA Updates 206 are merged with the existing CCFA list, creating a list of CFAs and their respective ACs 202. The list 202 is then forwarded to CCFA Display Engine 215. In one embodiment, the CCFA list may be stored internally in the CCFA engine or in another embodiment may be remotely stored and accessible by the CCFA engine, when needed.

Outside of the CCFA engine 103, the supporter 104 may engage in normal activity using the electronic device having the CCFA engine 103 therein. For example, if the CCFA engine 103 is in a personal computing device, the supporter 104 may use the computing device to load a browser application and view various web pages via an Internet connection.

Context Sensor 211 in the CCFA engine 103 gathers information about the Current Context 203 of the CCFA engine 103 and more generally about the operations of the processing device in which the CCFA engine 103 is hosted. This current context information 203 may include, for example, information about OS context (e.g., which program the user is interacting with right now) and about specific program contexts (e.g., which site the user is browsing right now, which files the user is sharing via P2P networks). The Current Context 203 is then sent to the CCFA Display Engine 215.

CCFA Display Engine 215 continuously compares Current Context 203 with the AC list 202. Whenever a match is found between the context information 203 and the AC items in the list 202, the CCFA Display Engine 215 displays a CFA 204 the supporter 104.

Displaying a CFA 204 can be done by displaying texts, image, web link, audio, video, or any other kind of media or combination thereof. As described and illustrated in further detail below, the display of this information may be in any of a number of various formats to provide the CFA to the user without being cumbersome, overly intrusive and/or disruptive to the user 104. The user 104 may thereupon take an action as requested in the CFA 204.

In a further embodiment, the Stats Engine 214 receives reports from CCFA Display Engine 215 whenever a CFA 204 is displayed to the user. The stats engine 214 may be a computing device or processing module operative to assemble and process the statistic information 205 from the CCFA display engine 215 for subsequent providing to the coordination center 101.

In one embodiment, the CCFA Display Engine 215 will also report what the user has done in response to CFA 204 (e.g., clicked on a link embedded inside the CFA 204). The CCFA display engine 215 may monitor additional user activity, where available, and track or otherwise monitor user activities relating to the CFA. For example, if the user sends an email message to an editor or posts a message on a message board, the engine 215 may take note of this activity and include it in the statistics for activities taken in response to the CFA. It is recognized that other non-electronic actions may not be as readily recognized, such as where a person handwrites a letter, mails a letter using the postal system sends a fax, by way of example. In these cases, the engine 215 may not include this information or in another embodiment may include follow-up interactivity whereupon the user could provide information that a particular action was taken.

Stats Engine 214 periodically sends reports 206 to the coordination center 101. In one embodiment, the reports 206 may include the stats data 205 as well as additional information as recognized by one skilled in the art. For example, data may include information on the operations performed by the CCFA engine 103 as well as the context information 203, which can indicate the overall activities of the supporter 104 when using the device that includes the CCFA engine 103. It is also recognized that for privacy concerns, the reports 206 may include limited amounts of information or may be cleansed to remove user identification information, where appropriate.

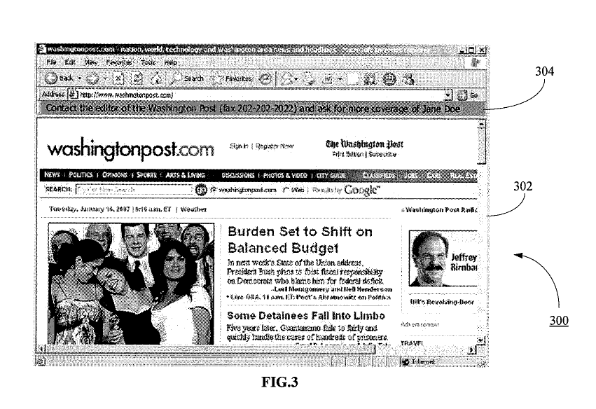

FIG. 3 shows an example of a screenshot 300 of the user experience of a supporter using the contextual call-for-action system described above. The supporter is viewing a news-related article by browsing a newspaper article on a web browser application 302. Based on a recognition on the AC of viewing a particular article about a particular topic, the CFA 304 is displayed to “Contact the editor of the Washington Post (fax 202-202-2022) and ask for more coverage of Jane Doe”. Unlike traditional methods, such as emails, the CFA is only shown when the supporter is in the right context, which in this exemplary screenshot 300 is viewing a particular article 302 about a particular topic. As visible in the screenshot 300, the CFA is unobtrusive by being not only contextual but also visually appealing in a small bar portion of the web browser.

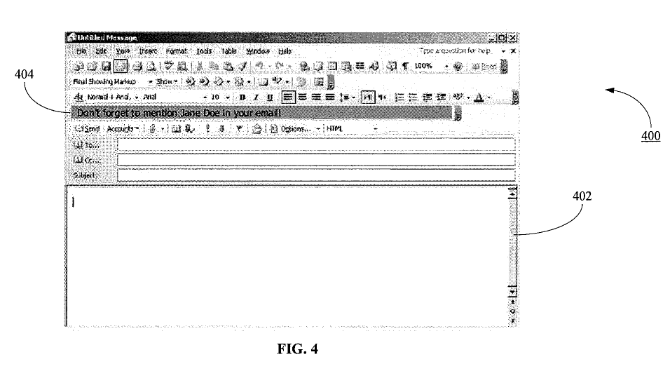

FIG. 4 shows another example of a screenshot 400 of the user experience of a supporter using the contextual call-for-action system. The screenshot displays an email-related CFA (“Don't forget to mention Jane Doe in your email!”) while using an email software to compose a new message. In the CCFA engine, the CCFA display engine 215 of FIG. 2 recognizes the current context 203 of an email being prepared, as noted by the context sensor 211. The email 402 includes a CFA 404, which similar to the CFA 304 of FIG. 3, is contextual to the supporter's activity of preparing an email.

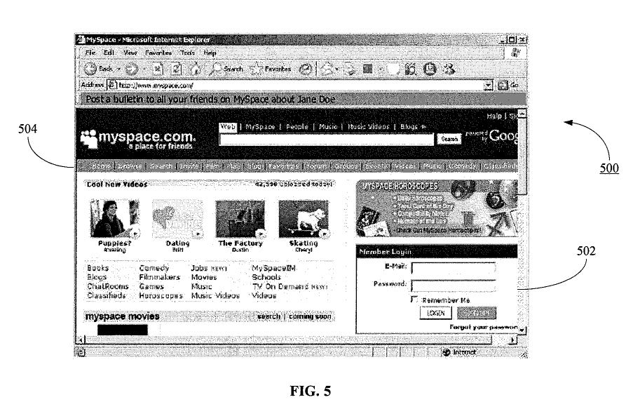

FIG. 5 shows another example of the user experience of a supporter using the contextual call-for-action system. The supported is showing a social-network-related CFA (“Post a bulletin to all your friends on MySpace about Jane Doe”) while browsing the relevant social network (MySpace).

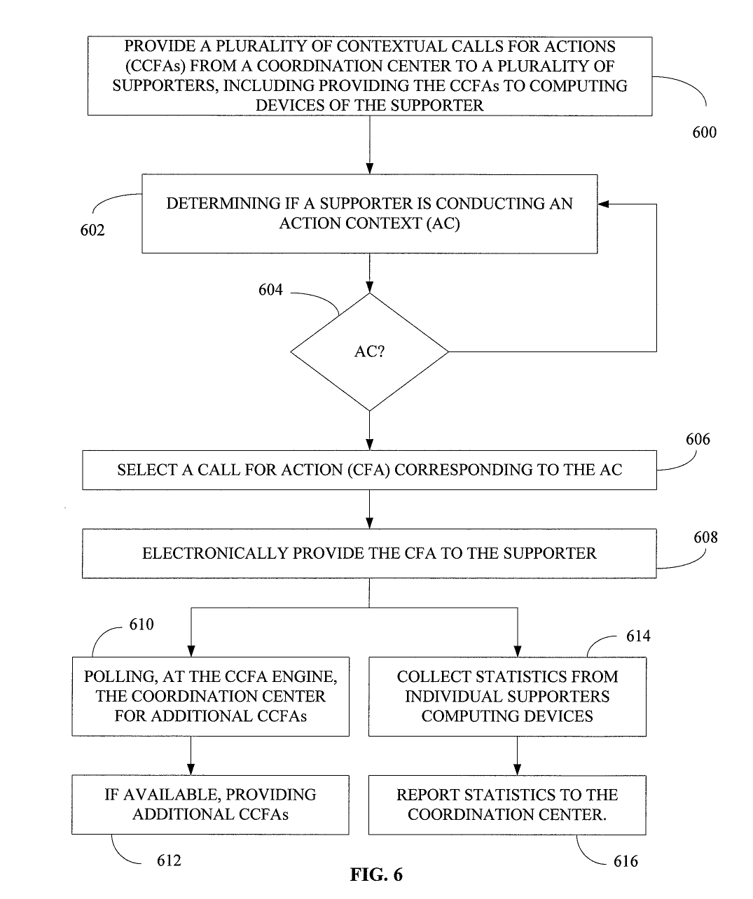

FIG. 6 illustrates a flowchart of the steps of one embodiment of a method for requesting CCFAs. This method may be computer-implemented, such as described above regarding FIGS. 1 and 2. For example, the method steps may be performed by a processing device performing operations in response to executable instructions stored in a computer readable media.

A first step in the method, step 600, is providing a plurality of contextual calls for action (CCFAs) from a coordination center to a plurality of supporters, including providing the CCFAs to the supporters' computing devices. For example, as illustrated in FIG. 1, the coordination center 101 provides the CCFAs to the CFA engines 103 via the communication network 102

A next step, step 602, is determining if a supporter is conducting an action context (AC). In other words, the CCFA engine 103 monitors the supporter's activities, such as using the context sensor 211 to send context information 203 to the CCFA display engine 215 as illustrated in FIG. 2.

A next step, 604 is a determination if the supporter's actions match a CA. For example, in one embodiment, the CCFA display engine 215 compares the context information 203 with the CFA and the CA list 202.

If the inquiry to step 604 is in the negative, the supporter's activities do not match any AC, the method may thereupon revert back to step 602. Although, if in the affirmative, the method continues to step 606, which includes selecting a call for action (CFA) corresponding to the AC. As described above, this may be performed, in one embodiment, using a look-up or reference table to retrieve a CFA based on the AC, such as may be performed by the CCFA display engine 215 of FIG. 2.

In the embodiment illustrated in FIG. 6, a final step, step 608, is to electronically provide the CFA to the supporter. This may be performed by the CCFA display engine 215 providing the CFA 204 to the user/supporter 104. In various embodiments, this may be provided in an unobtrusive manner, such as illustrated in the sample screenshots of FIGS. 3-5.

In another embodiment, the method may further include the CCFA engine polling the coordination center for additional CCFAs, step 610. Or as an alternative, the CCFA engine may broadcast or push new CCFAs to the CCFA engine. If additional CCFAs are available, step 612 includes providing the additional CCFAs to the CCFA engine, such as across the network 102 of FIG. 1. These additional CCFAs may supplement and/or replace already stored CCFAs in the engine.

In another embodiment of the flowchart of FIG. 6, after step 608, the method may include collecting statistics from individual supporter's computer devices, step 614. This data may include information on whether the supporter viewed on the CFA, performed an action in response to the CFA, how long the supported took between receiving the CFA and performing the action, and any other suitable information. The method may further include, step 616, reporting statistics to the coordination center 101. Steps 614 and 616 may be more generally indicated as monitoring and managing a response rate to specific CCFAs because based on the statistic information, feedback information may be utilized to modify the CCFA, such as updating the CFA and provided back to the supporter in steps 610 and 612.

Thereby, a supporter can be provided with a CCFA in an unobtrusive manner based on the supporter's actions using his or her electronic device having the CCFA engine therein. The CCFAs are unobtrusive because they are timely relative the user's action and hence can be more effective for promoting activism by having a reduce likelihood to be ignored by the supporter.

System 100 can be used to increase the likelihood of supporters actually acting upon each call-for-action (compared to existing, non-contextual means of communicating calls-for-action) since the CFAs are shown to supporters in context. Additionally, system 100 can be used to increase the number of calls-for-actions issued at the same time without alienating supporters (compared to existing, non-contextual means of communicating calls-for-action) or to create permanent calls-for-action (unlike existing, non-contextual means of communicating calls-for-action which are transitory in nature).

Other business model and technical aspects would become apparent to those skilled in the relevant art(s) in view of the teachings of the present disclosure. FIGS. 1-5 are conceptual illustrations allowing an explanation of the present invention. It should be understood that various aspects of the embodiments of the present invention could be implemented in hardware, firmware, software, or a combination thereof. In such an embodiment, the various components and/or steps would be implemented in hardware, firmware, and/or software to perform the functions of the present invention. That is, the same piece of hardware, firmware, or module of software could perform one or more of the illustrated blocks (i.e., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by a processor to cause the processor to perform the functions of the invention as described herein. In this document, the terms “machine readable medium,” “computer program medium” and “computer usable medium” are used to generally refer to media such as a removable storage unit (e.g., a magnetic or optical disc, flash ROM, or the like), a hard disk, signals (i.e., electronic, electromagnetic, or optical signals), or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the art.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A computer-implemented method for requesting contextual calls-for-action (CCFA), the method comprising:
providing a plurality of CCFAs from a coordination center to a plurality of supporters, including providing the CCFAs to computing devices of the supporters;
determining if a supporter is conducting an action context (AC);
if the supporter is conducting the AC, selecting a call-for-action (CFA) corresponding to the AC; and
electronically providing the CFA to the supporter.

2. The method of claim 1 wherein the step of determining if the supporter is conducting an AC includes:
monitoring user activity; and
comparing this activity to action context parameters.

3. The method of claim 2, wherein action context parameters may include at least one of: visiting a web address, preparing an electronic message, reading an electronic newspaper, visiting a social networking site, watching an online video, sharing electronic files and run a recognized executable program.

4. The method of claim 3 wherein the CFA includes at least one: text, images, web links, audio, video and executable program for displaying instructions relating to an action of the CFA when the monitored user activity matches one of the action context parameters.

5. The method of claim 1 further comprising:
centrally storing the plurality of CCFAs in a coordination center; and
providing the plurality of CCFAs to a CCFA engine across a networked connection.

6. The method of claim 5 further comprising:
polling, at the CCFA engine, the coordination center for additional CCFAs; and
if additional CCFAs, providing the additional CCFAs to the CCFA engine.

7. The method of claim 1 further comprising:
monitoring and managing a response rate to specific CCFAs, which includes:
collecting statistics from individual supporters' computing devices about the CFAs displayed to supporters and actions taken by the supporters; and
reporting these statistic to a coordination center.

8. A system for requesting contextual calls-for-action (CCFA), the system comprising:
a computer readable medium having executable instructions stored thereon; and
a processing device, in response to the executable instructions, operative to:
provide a plurality of CCFAs from a coordination center to a plurality of supporters, including providing the CCFAs to computing devices of the supporters;
determine if a supporter is conducting an action context (AC);
if the supporter is conducting the AC, select a call-for-action (CFA) corresponding to the AC; and
electronically provide the CFA to the supporter.

9. The system of claim 8 wherein when the processing operation determines if the supporter is conducting an AC, the processing device is further operative to:
monitor user activity; and
compare this activity to action context parameters.

10. The system of claim 9, wherein action context parameters may include at least one of: visiting a web address, preparing an electronic message, reading an electronic newspaper, visiting a social networking site, watching an online video, sharing electronic files and run a recognized executable program.

11. The system of claim 10, wherein the CFA includes at least one: text, images, web links, audio, video and executable program for displaying instructions relating to an action of the CFA when the monitored user activity matches one of the action context parameters.

12. The system of claim 8, further comprising:
a coordination center centrally storing the plurality of CCFAs; and
a CCFA engine operative to receive the plurality of CCFAs to across a networked connection.

13. The system of claim 12, the processing device, in response to further executable instructions, is further operative to poll, at the CCFA engine, the coordination center for additional CCFAs and the CCFA operative to receive the additional CCFAS, if available.

14. The system of claim 8, the processing device, in response to further executable instructions, is further operative to
monitor and manage a response rate to specific CCFAs, which includes
collecting statistics from individual supporters' computing devices about the CFAs displayed to supporters and actions taken by the supporters; and
reporting these statistic to a coordination center.

15. A computer readable medium storing program code that when executed by a programmable processor causes the process to execute a method for requesting contextual calls-for-action (CCFA), the computer readable medium comprising:
programming code for providing a plurality of CCFAs from a coordination center to a plurality of supporters, including providing the CCFAs to computing devices of the supporters;
programming code for determining if a supporter is conducting an action context (AC);
if the supporter is conducting the AC, programming code for selecting a call-for-action (CFA) corresponding to the AC; and
programming code for electronically providing the CFA to the supporter.

16. The computer readable medium of claim 15 wherein the step of determining if the supporter is conducting an AC includes:
programming code for monitoring user activity; and
programming code for comparing this activity to action context parameters.

17. The computer readable medium of claim 16, wherein action context parameters may include at least one of: visiting a web address, preparing an electronic message, reading an electronic newspaper, visiting a social networking site, watching an online video, sharing electronic files and run a recognized executable program.

18. The computer readable medium of claim 17 wherein the CFA includes at least one: text, images, web links, audio, video and executable program for displaying instructions relating to an action of the CFA when the monitored user activity matches one of the action context parameters.

19. The computer readable medium of claim 15 further comprising:
programming code for centrally storing the plurality of CCFAs in the coordination center; and
programming code for providing the plurality of CCFAs to a CCFA engine across a networked connection.

20. The computer readable medium of claim 19 further comprising:
programming code for polling, at the CCFA engine, the coordination center for additional CCFAs; and
if additional CCFAs, programming code for providing the additional CCFAs to the CCFA engine.

21. The computer readable medium of claim 15 further comprising:
programming code for monitoring and managing a response rate to specific CCFAs, which includes
programming code for collecting statistics from individual supporters' computing devices about the CFAs displayed to supporters and actions taken by the supporters; and
programming code for reporting these statistic to a coordination center.
